(19) United States
(12) Patent Application Publication
(10) Pub. No.: US 2015/0181495 A1
(43) Pub. Date: Jun. 25, 2015

(54) INVOLVING TRAFFIC-TO-PILOT RATIO IN MEASUREMENT REPORTS AND IN LAYER-1 PROCEDURES FOR IMPROVED CALL PERFORMANCE

(71) Applicant: QUALCOMM Incorporated, San Diego, CA (US)

(72) Inventors: Sharif Ahsanul MATIN, San Diego, CA (US); Maulik Oza, San Diego, CA (US); Wei Zhang, Santa Clara, CA (US); Shashank Vishwanatha Maiya, Sunnyvale, CA (US)

(21) Appl. No.: 14/316,582

(22) Filed: Jun. 26, 2014

Related U.S. Application Data
(60) Provisional application No. 61/920,403, filed on Dec. 23, 2013.

(51) Int. Cl. H04W 36/30; H04W 72/04; H04W 36/00; H04W 36/38

(52) U.S. Cl. CPC H04W 36/30; H04W 36/38; H04W 72/0406; H04W 36/0061

(57) ABSTRACT

Methods and apparatuses for wireless communication and cell monitoring and handover using a downlink dedicated physical channel (DL-DPCH) traffic-to-pilot ratio (TPR) are presented. For example, a method of mobile communication at a user equipment (UE) is presented, which may include starting a time-to-trigger (TTT) interval associated with a neighbor cell in preparation for potential handover of the UE to the neighbor cell according to network-assigned parameters. In addition, the example method may include monitoring a TPR associated with a DL-DPCH of a serving cell of the UE. Furthermore, the example method may include determining that the TPR exceeds a TPR threshold and shortening the TTT interval upon that determination. Moreover, the example method may include transmitting, based on the shortened TTT interval, a Measurement Report Message (MRM) to a network to add the neighbor cell to an active set associated with the UE.

### CROSS REFERENCE TO RELATED APPLICATIONS

The present Application for Patent claims priority to Provisional Application No. 61/920,403 entitled “Method and Apparatus for Involving Traffic-to-Pilot in Measurement Reports and Layer-1 Procedures for Improved Call Performance” filed Dec. 23, 2013, and assigned to the assignee hereof and hereby expressly incorporated by reference herein.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Traditionally, other than few timing related aspects, the measurement quantities involving powers for intra-frequency and/or inter-frequency measurement procedures have been based on Common Pilot strength or its derivatives. Different metrics of reporting, such as pilot signal-to-interference ratio (SIR, Ec/Io), received signal code power (RSCP), path loss, etc. (depending on a particular network configuration) are each based, to some extent, on pilot signals transmitted on the Common Pilot Channel (CPICH). This typical operation is based on the underlying assumption that the overhead channels of different cells, including CPICH, are a fair representative metrics of radio frequencies for call maintenance and that the powers contributed by different cells on different dedicated links to user equipment (UE) are fairly similar, irrespective of overhead channel conditions.

This assumption, however, further assumes a balanced network. In practice, this is not always the case. Instead, the power balancing algorithm for the downlink dedicated physical channel (DL-DPCH) may be ineffective for different intra-frequency handovers.

Furthermore, different uplink (UL) interference and loading characteristics may exist for different cells within an active set associated with a UE. As a result, the downlink (DL) Transmit Power Control (TPC) commands sent by the UE to the network can be interpreted differently by different cells. For example, the cell with higher uplink (UL) interference can mistakenly interpret “up” commands as “down” commands, leading to a lower DL power in return. Sometimes, NodeBs and/or cells associated with the NodeBs utilize a relatively high DL dedicated pilot power, perhaps a maximum allowed power, but the interference across the cells may be significantly different. As a result, the DPCH SIR values associated with the cells and received by the UE may become different. This leads to the conclusion that strong overhead channel power in certain links does not necessarily imply strong dedicated power contribution from those links.

As the demand for mobile broadband access continues to increase, research and development continue to advance the UMTS technologies not only to meet the growing demand for mobile broadband access, but to advance and enhance the user experience with mobile communications. Thus, a need exists for improved methods and apparatuses that may improve power indication, active set maintenance, and handover procedures in wireless networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with improving wireless communication functionality associated with a UE. In an aspect, an example method of wireless communications is presented that includes starting a time-to-trigger (TTT) interval associated with a neighbor cell in preparation for potential handover of the UE to the neighbor cell according to network-assigned parameters. In addition, the example method may include monitoring a TPR associated with a DL-DPCH of a serving cell of the UE. Furthermore, the example method may include determining that the TPR exceeds a TPR threshold and shortening the TTT interval upon a determination that the TPR meets or exceeds the TPR threshold. Moreover, the example method may include transmitting, based on the shortened TTT interval, a Measurement Report Message (MRM) to a network to add the neighbor cell to an active set associated with the UE.

In an additional aspect of the present disclosure, an example apparatus for mobile communication is presented, which may include means for starting a TTT interval associated with a neighbor cell in preparation for potential handover of a UE to the neighbor cell according to network-assigned parameters. Additionally, the example apparatus may include means for monitoring a TPR associated with a DL-DPCH of a serving cell of the UE. Furthermore, the example apparatus may include means for determining that the TPR exceeds a TPR threshold and means for shortening the TTT interval upon a determination that the TPR exceeds the TPR threshold. Moreover, the example apparatus may include means for transmitting, based on the shortened TTT interval, an MRM to a network to add the neighbor cell to an active set associated with the UE.

Additionally, the present disclosure presents an example non-transitory computer-readable storage medium, comprising instructions, that when executed by a processor, cause the processor to start a TTT interval associated with a neighbor cell in preparation for potential handover of a UE to the neighbor cell according to network-assigned parameters. In addition, the example computer-readable medium may include instructions, that when executed by the processor, cause the processor to monitor a TPR associated with a DL-DPCH of a serving cell of the UE. Furthermore, the example computer-readable medium may include instructions, that when executed by the processor, cause the processor to determine that the TPR exceeds a TPR threshold and to shorten the TTT interval upon a determination that the TPR exceeds the TPR threshold. Moreover, the example computer-readable medium may include instructions, that when executed by the processor, cause the processor to transmit, based on the shortened TTT interval, an MRM to a network to add the neighbor cell to an active set associated with the UE.

Furthermore, the present disclosure presents an example UE, which may include a TTT starting component configured to start a TTT interval associated with a neighbor cell in preparation for potential handover of the UE to the neighbor cell according to network-assigned parameters. In an additional aspect, the example UE may include a TPR monitoring component configured to monitor a TPR associated with a DL-DPCH of a serving cell of the UE. Moreover, the example UE may include a comparison component configured to determine that the TPR exceeds a TPR threshold and a TTT interval shortening component configured to shorten the TTT interval upon a determination that the TPR exceeds the TPR threshold. Additionally, the example UE may include an MRM transmitting component configured to transmit, based on the shortened TTT interval, an MRM to a network to add the neighbor cell to an active set associated with the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless communications system according to the present disclosure;

FIG. 2 is a block diagram illustrating an example TPR manager according to an example apparatus of the present disclosure;

FIG. 3A is a flow diagram comprising a plurality of functional blocks representing an example methodology of the present disclosure;

FIG. 3B is a flow diagram comprising a plurality of functional blocks representing an example methodology of the present disclosure;

FIG. 4 is a diagram illustrating an example of a hardware implementation for an apparatus employing a processing system;

FIG. 5 is a block diagram conceptually illustrating an example of a telecommunications system;

FIG. 6 is a conceptual diagram illustrating an example of an access network; and

FIG. 7 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents methods and apparatuses for improved generation of MRMs and other layer 1 (L1) related aspects driven by a TPR, which is the ratio of the downlink DPCH power to the CPICH power associated with a particular cell. In an aspect, the TPR serves as an indicator of how well a particular link of a cell of a set of cells in an active set associated with the UE is contributing to the overall channel profile of a UE. For example, in an aspect, an active set may include a plurality of cells for which a radio link is established between the UE and the cell, each of which may have a unique associated TPR. One is able to determine the amount of power contributed by each cell of the active set by analyzing the TPR associated with each cell.

Accordingly, according to aspects of the present disclosure, TPR can serve as an important metric to influence measurement report procedures, particularly for handover scenarios (e.g., soft handover, softer handover). For example, in some instances, a UE may need to maintain call with a single cell with a high associated TPR for a relatively long time where the time-to-trigger (TTT) for the neighboring cells is likewise relatively long and needs sufficient time to expire (i.e. due to large timer settings by network) before being added to the active set associated with the UE. This makes a call vulnerable to being dropped, because by the time the TTT expires, an MRM is transmitted, and the UE begins receiving Active Set Update (ASU) messages, it may be too late for the cell to effectively serve the UE, for example, where the UE is in a high mobility state. For example, the DL signaling may begin experiencing repeated cyclic redundancy check (CRC) failures by the time the neighbor cell is added to the active set, which may lead to call failure.

In an aspect of the present disclosure, a UE may trigger an event 1a sooner than it would under traditional or legacy processes, for example, based on a high TPR for a cell in the active set and/or high correlation of CPICH Ec/Io and estimated signal-to-interference ratio (SIRE) plots. According to such an example aspect, as soon as a UE begins a TTT interval associated with an event 1a for a particular neighbor cell, it also monitors the TPR of the current dedicated transport channel (DCH). If the TPR value associated with the neighbor cell exceeds a certain threshold and/or number of cells in the active set is low, in an aspect of the present disclosure, the UE may prepare an event 1a for the neighboring cell. In an alternative or additional aspect of the present disclosure, when the correlation of SIRE and any CPICH Ec/Io exceeds (or in some examples, meets) a threshold measured over a past time window, the UE may be configured to immediately report an event 1a.

In an additional aspect, a UE may be configured to assess TPR values associated with each link before sending an event 1b report to the network to remove a cell associated with the link from the active set. For example, when the UE has multiple cells in the active set but the per-link TPR has a threshold difference between the cell with the strongest DPCH compared to the other cells, and if that strongest cell triggers an event 1b according to current standard network operation, the UE may postpone reporting the event 1b until some link equality is observed. In some examples, this link equality may consist of per-link SIRE for the other cell becoming comparable to the strongest cell. As such, cells that contribute a non-negligible link power in the active set may be maintained even though the strongest cell CPICH power satisfies the requisite conditions for reporting an event 1b according to traditional event reporting processes.

Furthermore, according to an aspect of the present disclosure, a UE may be configured to utilize similar TPR-based consideration as introduced above for early compressed mode (CM) triggering. For example, where the events involving CM generation (e.g., event 1f, event 2d) have a prolonged TTT or sluggish filter co-efficient and the TPR values of serving cells in the active set of the UE are diminishing over time (e.g., below a certain threshold for a particular time period) the UE may be configured to shorten the TTT for related event if or event 2d reporting messages.

Moreover, in addition to the intra-frequency and MRM-related applications of TPR discussed above, aspects of the present disclosure may apply to cell searching processes. In other words, in some examples, TPR values may be input to and utilized by cell search components and/or processes associated with a UE. For example, a UE may be configured to determine whether TPR consumption in a current cell and/or frequency meets or exceed a threshold value. Where the threshold is met or exceeded, the cell searching behavior of the UE may be modified to account for measured TPR. In some examples, search methods associated with the UE may be modified in terms of periodicity, depth, thresholds, or any other parameter or characteristic, due to urgency of finding other cells that may be added to the active set and/or may become target cells for inter-frequency, intra-frequency, or inter-radio-access-technology handover.

Accordingly, application of the methods presented in the present disclosure by one or more UEs in a wireless environment may result in a reduced probability of call drops in DL-DPCH power-limited scenarios when a TTT for a neighbor cell is shortened and an associated event 1a is reported to the network based on the shortened TTT. In addition, a UE may exhibit better average DPCH Ec/Io savings by being configured to selectively drop one or more high-interference cells from the active set or to drop those cells that contribute negligible per-link SIRE. In an additional improvement, call stability may be bolstered due to the compressed mode-specific method of assisting the UE in trigger events sooner in few specific cases, as well as modifying existing searching procedures based on TPR.

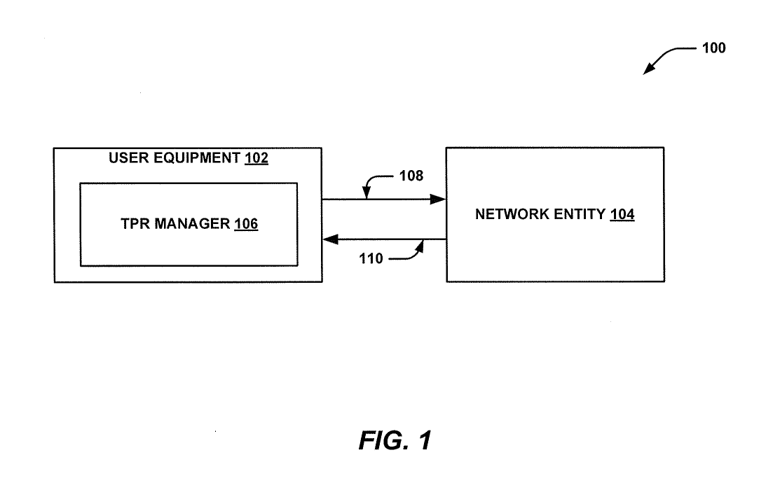

FIG. 1 is a schematic diagram illustrating a system 100 for improved UE uplink connection establishment, according to an example configuration. FIG. 1 includes an example network entity 104, which may communicate wirelessly with one or more UEs 102 over one or more wireless communication links. Furthermore, though a single network entity 104 is shown in FIG. 1, additional network entities may exist in system 100 and may communicate with UE 102 contemporaneously with network entity 104. These one or more network entities 104 may manage one or more cells that may transmit pilot or beacon signals 110 periodically (e.g., via a CPICH), which may be received, decoded, analyzed, and/or measured for power level by the UE 102. In an aspect, such a wireless communication link may comprise any over-the-air (OTA) communication link, including, but not limited to, one or more communication links operating according to specifications promulgated by 3GPP and/or 3GPP2, which may include first generation, second generation (2G), 3G, 4G, etc. wireless network architectures.

In addition, UE 102 may be configured to transmit one or more messages 108 (e.g., Measurement Report Messages (MRMs)) to network entity 104, which may indicate the received power levels of cells associated with network entities 104 and/or one or more events (e.g., event 1a, event 1b, or any other network- or specification-defined event) based on the received power levels of the cells. In addition, network entity 104 may transmit configuration information 110 to UE 102. In an additional aspect, UE 102 may include a TPR manager 106, which may be configured to manage one or more functions associated with a TPR value of links between the UE 102 and one or more cells or network entities 104. TPR manager 106 is described in further detail in the discussion of subsequent figures below.

In an aspect, UE 102 may be a mobile device, such as, but not limited to, a smartphone, cellular telephone, mobile phone, laptop computer, tablet computer, or other portable networked device. In addition, UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, UE 102 may be small and light enough to be considered portable and may be configured to communicate wirelessly via an over-the-air communication link using one or more OTA communication protocols described herein.

Furthermore, network entity 104 of FIG. 1 may include one or more of any type of network module, such as an access point, a macro cell, including a base station (BS), node B, eNodeB (eNB), a relay, a peer-to-peer device, an authentication, authorization and accounting (AAA) server, a mobile switching center (MSC), a radio network controller (RNC), or a low-power access point, such as a picocell, femtocell, microcell, etc. Additionally, network entity 104 may communicate with one or more other network entities of wireless and/or core networks.

Additionally, system 100 may include any network type, such as, but not limited to, wide-area networks (WAN), wireless networks (e.g. 802.11 or cellular network), the Public Switched Telephone Network (PSTN) network, ad hoc networks, personal area networks (e.g. Bluetooth®) or other combinations or permutations of network protocols and network types. Such network(s) may include a single local area network (LAN) or wide-area network (WAN), or combinations of LANs or WANs, such as the Internet.

Moreover, such network(s), which may include one or more network entities 104, may comprise a Wideband Code Division Multiple Access (W-CDMA) system, and may communicate with one or more UEs 102 according to this standard. As those skilled in the art will readily appreciate, various aspects described throughout this disclosure may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX®), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UEs 102, network entity 104) may be coupled to a core network via one or more wired or wireless connections.

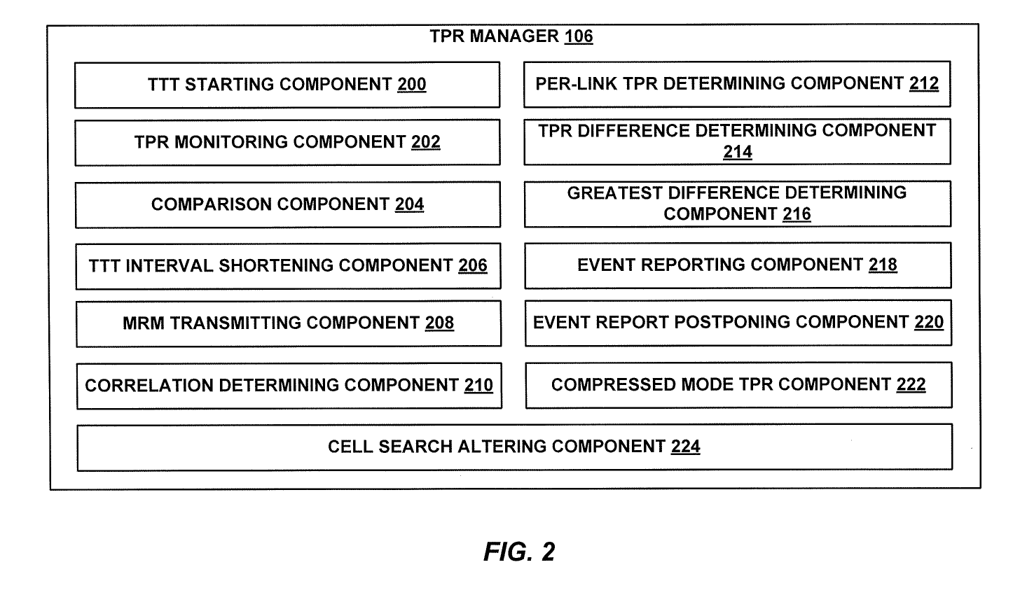

Turning to FIG. 2, an example TPR manager 106 (of FIG. 1, for example) is presented as comprising a plurality of individual components for carrying out the one or more methods or processes described herein. For example, in an aspect, TPR manager 106 may include a TTT starting component 200, which may be configured to start a TTT interval associated with a neighbor cell in preparation for potential handover of the UE to the neighbor cell according to network-assigned parameters. For example, the TTT starting component 200 may include a timer that may begin when a signal strength associated with a pilot signal transmitted by the neighbor cell reaches a threshold level for starting the TTT interval, such as, but not limited to, a pilot signal strength that is greater than a current serving cell associated with the UE and/or any other threshold level or hysteresis value at which the UE would recognize an event 1a according to network parameters provided by the network or an associated network entity.

In an additional aspect, TPR manager 106 may include a TPR monitoring component 202, which may be configured to monitor a TPR associated with one or more serving cells of the UE. In an aspect, TPR monitoring component 202 may be configured to monitor the TPR associated with links corresponding to each cell in an active set associated with the UE so as to determine a level at which each link and/or associated cell is contributing to overall communication and/or call performance between the UE and the network. By monitoring the TPR associated with each active link and/or cell in the active set, the TPR monitoring component 202 may determine which cells are to be kept in the active set and those which may serve as candidates to be dropped from the active set (e.g., via reporting an event 1b associated with the cell to the network.) In addition, for purposes of the present disclosure, the TPR may be defined as the ratio of DL-DPCH power to CPICH power. As such, TPR monitoring component 202 may be configured to likewise monitor the DL-DPCH power and CPICH power associated with each active link and/or cell in the active set associated with the UE.

Furthermore, TPR manager 106 may include a comparison component 204 configured to compare a TPR associated with one or more cells (e.g., neighbor cells relative to one or more cells of the active set) to a TPR threshold, for example, to determine whether the TPR exceeds a TPR threshold. In an aspect, the TPR threshold may be a distinct value supplied by the network and/or stored at the UE. In other examples, the TPR threshold may be dynamic. In other words, the TPR threshold may change based on the TPR values of other cells in the active set, the network with which the cell is associated, geography, time, historical TPR values of the cell or the cells of the active set, or any other metric that may change over time. For example, in some examples, the TPR threshold may comprise an average TPR associated with the active set at a given time or over a given historical time period, or the TPR value of the current cell with the highest TPR value of the active set.

In addition, comparison component 204 may be configured to compare the TPR of one or more cells that are currently in the active set to an active set removal TPR threshold associated with postponing or blocking the cell from being removed from the active set. For example, where a pilot signal (CPICH) power associated with a cell in the active set is below a threshold pilot signal power at which the UE would traditionally declare an event 1b according to legacy processes but has a TPR above the active set removal TPR threshold, the UE (e.g., via event report postponing component 220) may postpone reporting the event 1b to the network.

In addition, TPR manager 106 may include a TTT interval shortening component 206, which may be configured to shorten the TTT interval upon a determination that the TPR meets (or exceeds) the TPR threshold. In an aspect, the TTT interval shortening component 206 may shorten the TTT interval relative to a TTT interval associated with or supplied by a particular network or associated network entity. By shortening the TTT interval, the UE may expedite the process of adding a cell to its active set by shortening a time before the UE transmits a MRM to the network indicating the occurrence of an event 1a associated with a particular cell whose TPR meets or exceeds the TPR threshold.

Furthermore, TPR manager 106 may include an MRM transmitting component 208, which may be configured to transmit, based on the shortened TTT interval, an MRM to a network. In an aspect, the MRM may include an event indication, such as, but not limited to, and event 1a indication, which may prompt the network to add a neighbor cell to an active set associated with the UE.

In an additional aspect of the present disclosure, a UE may be configured to report an event 1a to add a monitored neighbor cell to the active set based on a correlation between an estimated signal-to-interference ratio (SIRE) of the DPCH and a signal-to-interference ratio (Ec/Io) associated with a Common Pilot Channel (CPICH) associated with a cell over a particular time window. In an aspect, by determining that such a correlation exists between the SIRE of the DPCH and Ec/Io of the CPICH, the UE may determine that the monitored neighbor cell should be added to the active set. Thus, TPR manager 106 may include a correlation determining component 210, which may be configured to determine that a correlation exists between the SIRE and the Ec/Io of the CPICH. In an aspect, where the correlation determining component 210 determines that such a correlation exists, it may inform MRM transmitting component 208 of the determined correlation. As a result, the MRM transmitting component 208 may generate an event 1a indication and may transmit an MRM including the event 1a indication to the network upon receiving the indication that the correlation exists.

In addition, to determine that such a correlation exists, correlation determining component 210 may be further configured to determine that a difference between the SIRE of the DPCH and the Ec/Io of the CPICH remains below a difference threshold over the time window. Where such a difference remains below the difference threshold, the correlation determination component 210 may determine that a correlation exists between the SIRE and the Ec/Io.

In a further aspect, TPR manager 106 may include a per-link TPR determining component 212, which may be configured to determine a per-link TPR associated with each cell of the active set associated with the UE. Furthermore, TPR manager 106 may include a TPR difference determining component 214, which may be configured to compare a greatest per-link TPR corresponding to the TPR of a strongest cell of the active set having a greatest signal strength (e.g., greatest DPCH power) to the per-link TPR of each other cell of the active set to generate at least one per-link TPR difference. Thus, the at least one per-link TPR difference may represent the difference between the TPR of the strongest cell (e.g., the cell having a greatest signal strength of the cells in the active set of the UE) and the TPR of one or more of the other cells of the active set.

By measuring these differences in per-link TPR, the UE can determine whether a link-specific TPR value equality (or “link equality”) exists between the cells in the active set before removing the strongest cell from the active set. Thus, in an aspect, the UE may postpone, based on a determination that the greatest-per link difference exceeds the TPR difference threshold, reporting an event 1b corresponding to the strongest cell until the at least one per-link TPR difference falls below a TPR difference threshold, which may indicate that a link equality (e.g., in terms of TPR) exists between the cells of the active set. This allows the UE to maintain the strongest cell in its active set even where the CPICH power associated with the strongest cell (in terms of TPR) would have otherwise caused the strongest cell to be dropped from the active set according to legacy protocols and/or network parameters.

As such, TPR manager 106 may include a greatest difference determining component 216, which may be configured to determine that the greatest per-link difference of the at least one per-link TPR difference exceeds a TPR difference threshold. In addition, TPR manager 106 may include an event reporting component 218, which may be configured to determine that an event 1b could be reported to the network for the strongest cell according to the network-assigned parameters, which may include parameters or protocols that instruct the UE that legacy methods of active set maintenance (e.g., those based on the received power of CPICH alone) are utilized by the network. However, as the UE of the present disclosure may base its event reporting and active set maintenance processes on TPR values, the TPR manager 106 may include an event report postponing component 220 configured to postpone reporting the event 1b for the strongest cell until the TPR difference meets a link equality value. In some examples, the TPR difference may be said to meet the link equality value where the TPR difference meets or falls below the TPR difference threshold. In a further aspect, event report postponing component 220 may be configured to postpone the reporting of the event 1b to the network based on a determination that the greatest-per link difference exceeds the TPR difference threshold. Furthermore, this postponement of the event 1b reporting for the strongest cell may be performed by event report postponing component 220 even where, according to the network-assigned parameters or legacy active set update protocols, the UE would have reported an event 1b to remove strongest cell from the active set of the UE.

In addition, the use of TPR for active set maintenance presented by the present disclosure is not limited to intra-frequency handover scenarios. Instead, these aspects may be implemented in inter-frequency and/or inter-radio-access-technology handover scenarios, as well. For example, in an aspect, a UE of the present disclosure may be configured to operate in compressed mode to allow the UE to monitor cells of different frequencies than the frequency or frequencies of cells currently in the active set of the UE. Compressed mode operation involves opening up transmission or reception gaps in a transmission or reception chain associated with a radio resource (e.g., transceiver, transmitter, receiver, antenna, or associated circuitry) to allow the UE to tune the radio resource to other frequencies to monitor signals (e.g., pilot or beacon signals) associated with cells operating according to these other frequencies.

Like the intra-frequency cell monitoring and handover scenarios described above, the UE may utilize TPR values associated with cells of different frequencies to potentially shorten the TTT required for adding these cells to the active set of the UE. As such, the TPR manager 102 may further include a compressed mode TPR component 222, which may be configured to shorten a compressed mode TTT associated with an event 1f reporting message or an event 2d reporting message upon a determination that the TPR meets a compressed mode TPR threshold. In an aspect, compressed mode TPR component 222 may be configured to determine a TPR of one or more cells while the UE is operating in compressed mode and may compare the determined TPR to a compressed mode TPR threshold to determine whether a TTT interval associated with the cell should be shortened (e.g., by TTT interval shortening component 206) to expedite the addition of the cell to the UE active set. Thus, the compressed mode TPR component 222 may ensure that cells having relatively high TPR are added to the active set of the UE, including cells operating according to frequencies or radio access technologies that differ from one or more cells currently in the active set of the UE.

In an additional aspect, TPR manager 106 may include a cell search altering component 224, which may be configured to alter a cell search procedure based upon the TPR of one or more neighbor cells. For example, in an aspect, the cell search altering component may be configured to alter a periodicity or a threshold neighbor cell signal power level associated with a cell search procedure to utilize TPR of one or neighbor cells in the cell search procedure.

Through the exemplary components illustrated in FIG. 2 are presented in reference to TPR manager 106 of FIGS. 1 and 2, they are not exclusive. Instead, TPR manager 106 may include additional or alternative components configured to perform aspects of the present disclosure and the claims below.

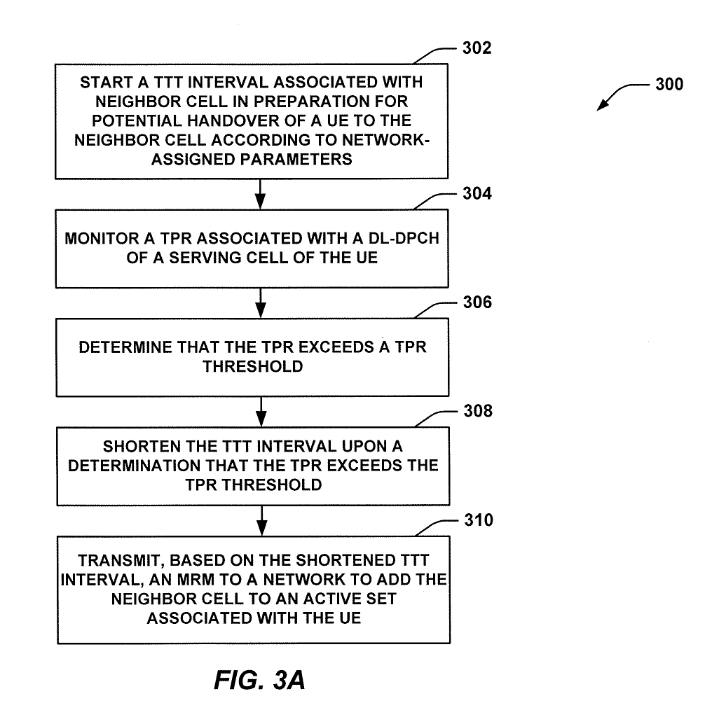

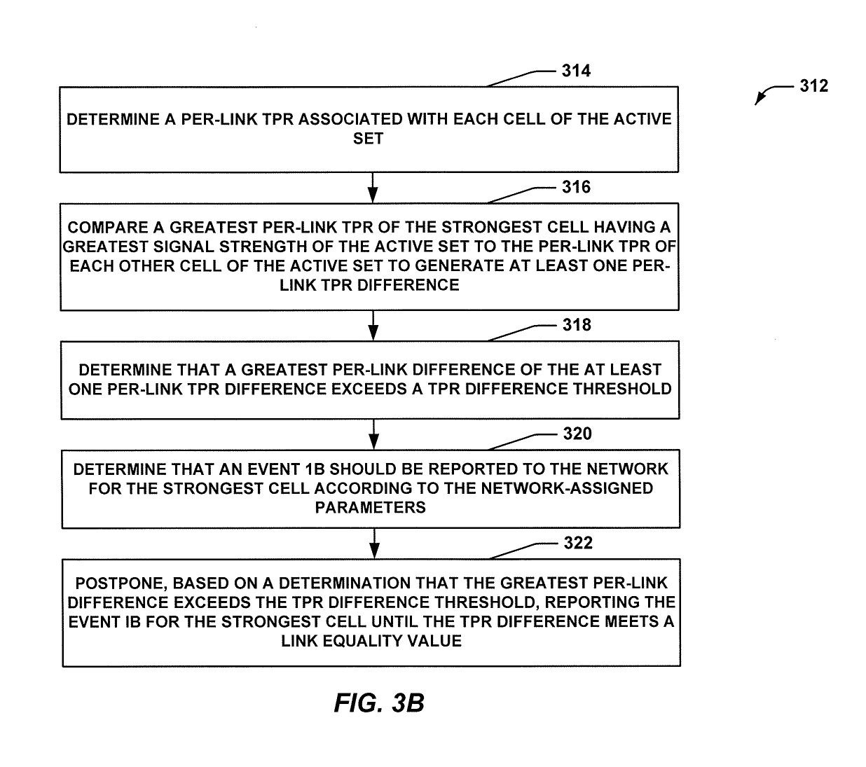

FIG. 3A presents an exemplary methodology 300 comprising a non-limiting set of steps represented as blocks that may be performed by one or more apparatuses described herein (e.g. a processing device or user equipment). In an aspect, methodology 300 may comprise a method of mobile communication at a user equipment, and may include, at block 302, starting a TTT interval associated with a neighbor cell in preparation for potential handover of the UE to the neighbor cell according to network-assigned parameters. In an aspect, block 302 may be performed by TTT starting component 200 of FIG. 2. Furthermore, the network-assigned parameters according to which the TTT interval is started may comprise parameters associated with legacy active set maintenance, including parameters (or processes) that do not rely on TPR for active set maintenance or event reporting associated with cell monitoring.

In addition, methodology 300 may include, at block 304, monitoring a TPR associated with a DL-DPCH of a serving cell of the UE. In an aspect, the serving cell of the UE may comprise a cell currently in the active set of the UE. In an aspect, block 304 may be performed by TPR monitoring component 202 of FIG. 2.

Furthermore, methodology 300 may include, at block 306, determining that the TPR exceeds a TPR threshold. In some examples, block 306 may include comparing the TPR of a serving cell of the UE in the active set to the TPR threshold. In addition, block 306 may be performed by comparison component 204 of FIG. 2.

In an additional aspect, methodology 300 may include, at block 308, shortening the TTT interval upon a determination that the TPR meets the TPR threshold. In an aspect, this shortening may include shortening the TTT associated with a monitored neighbor cell by a particular time period that may be stored in the UE. In addition, the particular time period by which the TTT is shortened may be based on a TPR level of the serving cell and/or the number of cells currently in the active set. As such, where the serving cell has a high TPR and may be dropped in a relatively short time in the future, the TTT may be shortened by a relatively large percentage of the network-specified TTT to assure that sufficient cell diversity exists in the active set and the probability of a call being dropped may be correspondingly reduced. Likewise, where the number of cells in the active set is relatively low (e.g., below a threshold amount), the UE may shorten the TTT interval by a relatively large percentage of the network-specified TTT to ensure that cell diversity exists in the active set. In an aspect, block 308 may be performed by TTT interval shortening component 208 of FIG. 2.

Moreover, at block 310, methodology 300 may include transmitting, based on the shortened TTT interval, an MRM to a network (or associated network entity) to add the neighbor cell to an active set associated with the UE. In an aspect, the MRM may include one or more event indications that indicate a particular event, such as, but not limited to, an event 1a associated with a neighbor cell. Additionally, block 310 may be performed by MRM transmitting component 208 of FIG. 2.

Furthermore, though not specifically shown in reference to methodology 300 of FIG. 3, methodology 300 may include one or more further steps or processes. For example, in an aspect, methodology 300 may include determining (e.g., by correlation determining component 210 of FIG. 2) that a correlation exists between an estimated SIRE and a signal-to-interference ratio (Ec/Io) associated with a CPICH over a time window. In an aspect, determining that the correlation exists between the SIRE and the Ec/Io may include determining that a difference between the SIRE and the Ec/Io remains below a difference threshold over the time window. Additionally, methodology 300 may include transmitting the MRM to the network (e.g., by MRM transmitting component 210 of FIG. 2) upon a determination that the correlation exists.

In an additional aspect, methodology 300 may include shortening (e.g., by compressed mode TPR component 222) a compressed mode TTT associated with an event 1f reporting message or an event 2d reporting message upon a determination that the TPR meets a compressed mode TPR threshold. Additionally, methodology 300 may include altering (e.g., by cell search altering component 224) a cell search procedure based upon the TPR. In some examples, altering the cell search procedure may include altering a periodicity or a threshold neighbor cell signal power level associated with the cell search procedure.

FIG. 3B presents an exemplary methodology 312 comprising a non-limiting set of steps represented as blocks that may be performed by one or more apparatuses described herein (e.g. a processing device or user equipment). In an aspect, methodology 312 may be related to methodology 300 of FIG. 3A. In other words, in some examples, aspects of methodology 312 of FIG. 3B may be performed in conjunction with aspects of methodology 300 of FIG. 3A. In other examples, the aspects of FIG. 3B described herein may be performed independent of methodology 300 of FIG. 3A.

In an aspect, methodology 312 of FIG. 3B may comprise a method of mobile communication at a user equipment, and may include, at block 314, determining (e.g., by per-link TPR determining component 212 of FIG. 2) a per-link TPR associated with each cell of the active set. Furthermore, methodology 312 may include, at block 316, comparing a greatest per-link TPR of a strongest cell having a greatest signal strength of the active set to the per-link TPR of each other cell of the active set to generate at least one per-link TPR difference. In an aspect, this comparison may be performed by TPR difference determining component 214 of FIG. 2. Additionally, methodology 312 may include, at block 318, determining (e.g., by greatest difference determining component 216) that a greatest per-link difference of the at least one per-link TPR difference exceeds a TPR difference threshold. Furthermore, methodology 312 may include, at block 320, determining (e.g., by event reporting component 218) that an event 1b could be reported to the network for the strongest cell according to the network-assigned parameters. Moreover, methodology 312 may include, at block 322, postponing, based on a determination that the greatest-per link difference exceeds the TPR difference threshold, reporting the event 1b for the strongest cell (e.g., by event report postponing component 220) until the TPR difference meets a link equality value.

It is to be understood that the specific order or hierarchy of various aspects in the methods disclosed is an illustration of exemplary processes. Based upon design preferences, it is understood that the specific order or hierarchy of various aspects in the methods may be rearranged. The accompanying method claims present elements of the various aspects in a sample order, and are not meant to be limited to the specific order or hierarchy presented unless specifically recited therein.

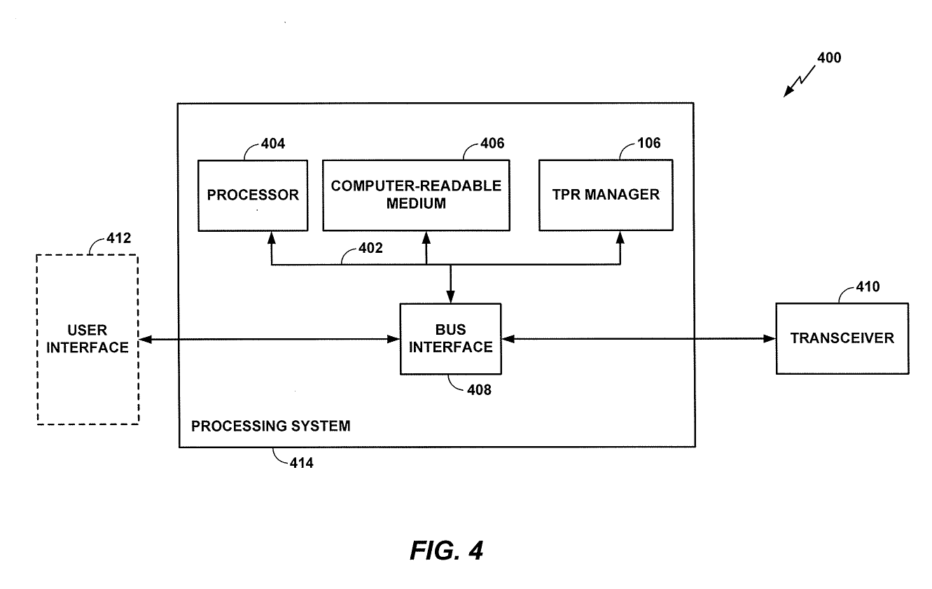

FIG. 4 is a conceptual diagram illustrating an example of a hardware implementation for an apparatus 400 employing a processing system 414. In some examples, the processing system 414 may comprise a UE or a component of a UE. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, computer-readable media, represented generally by the computer-readable medium 406, and an TPR manager 106 (see FIG. 1), which may be configured to carry out one or more methods or procedures described herein. In an aspect, the TPR manager 106 and the components therein may comprise hardware, software, or a combination of hardware and software that may be configured to perform the functions, methodologies (e.g., methodology 300 of FIG. 3), or methods presented in the present disclosure.

The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described infra for any particular apparatus. The computer-readable medium 406 may also be used for storing data that is manipulated by the processor 404 when executing software. In some aspects, at least a portion of the functions, methodologies, or methods associated with the TPR manager 106 may be performed or implemented by the processor 404 and/or the computer-readable medium 406.

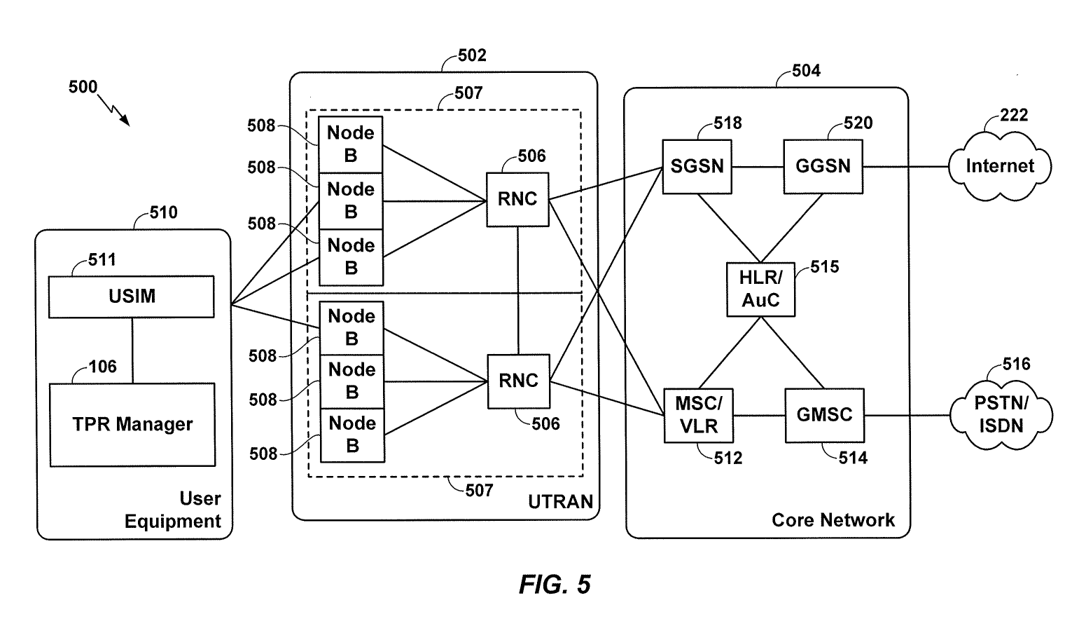

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 500 employing a W-CDMA air interface. A UMTS network includes three interacting domains: a Core Network (CN) 504, a UMTS Terrestrial Radio Access Network (UTRAN) 502, and User Equipment (UE) 510. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each SRNS 507; however, the SRNSs 507 may include any number of wireless Node Bs. The Node Bs 508 provide wireless access points to a core network (CN) 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. In addition, UE 510 may include TPR manager 106, the composition and functionality of which are described throughout the present disclosure (see, e.g., FIGS. 1-3). For illustrative purposes, one UE 510 is shown in communication with a number of the Node Bs 508. The downlink (DL), also called the forward link, refers to the communication link from a Node B 508 to a UE 510, and the uplink (UL), also called the reverse link, refers to the communication link from a UE 510 to a Node B 508.

The core network 504 interfaces with one or more access networks, such as the UTRAN 502. As shown, the core network 504 is a GSM core network. However, as those skilled in the art will recognize, the various concepts presented throughout this disclosure may be implemented in a RAN, or other suitable access network, to provide UEs with access to types of core networks other than GSM networks.

The core network 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a visitor location register (VLR) that contains subscriber-related information for the duration that a UE is in the coverage area of the MSC 512. The GMSC 514 provides a gateway through the MSC 512 for the UE to access a circuit-switched network 516. The core network 504 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The core network 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 508 and a UE 510. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

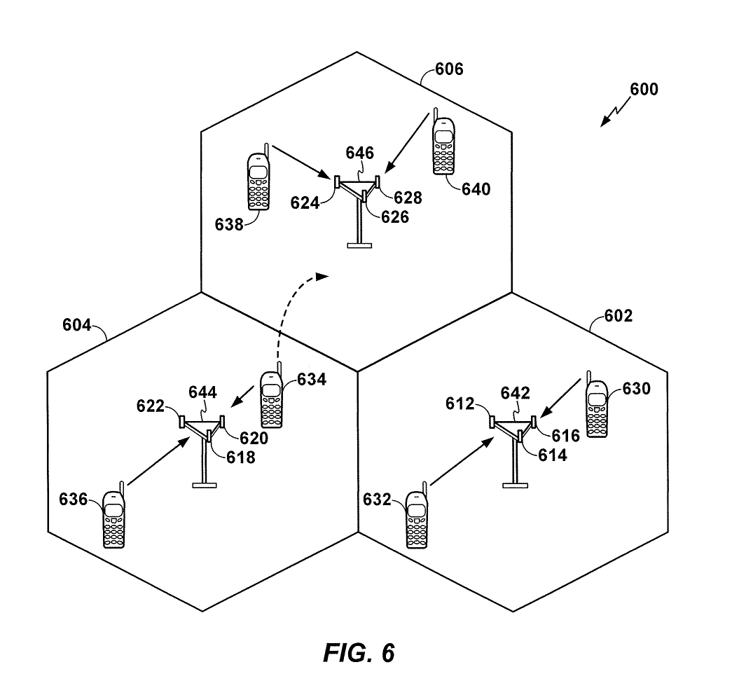

Referring to FIG. 6, an access network 600 in a UTRAN architecture is illustrated. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., User Equipment or UEs, which may be in communication with one or more sectors of each cell 602, 604 or 606, and may represent UE 102 of FIG. 1 having an TPR manager 106 as described herein. For example, UEs 630 and 632 may be in communication with Node B 642, UEs 634 and 636 may be in communication with Node B 644, and UEs 638 and 640 can be in communication with Node B 646. Here, each Node B 642, 644, 646 is configured to provide an access point to a core network 504 (see FIG. 5) for all the UEs 630, 632, 634, 636, 638, 640 in the respective cells 602, 604, and 606.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set).

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

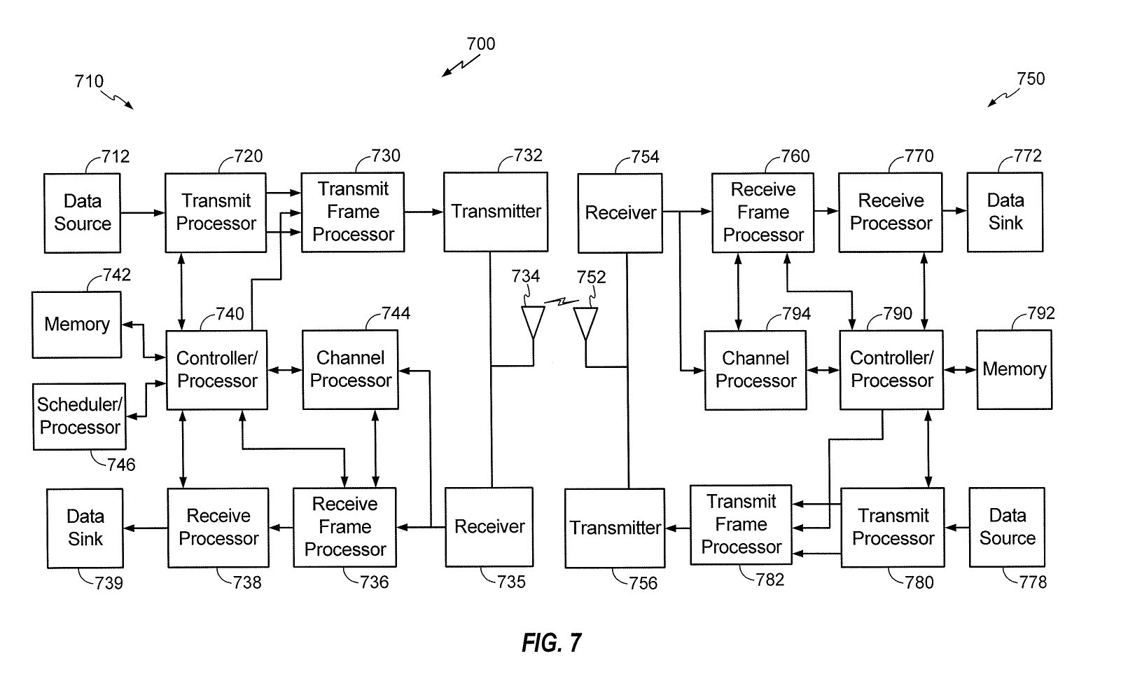

FIG. 7 is a block diagram of a Node B 710 in communication with a UE 750, where the Node B 710 may be the network entity 104 in FIG. 1, and the UE 750 may be the UE 102 in FIG. 1 having the TPR manager 106. In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), whichever is appropriate, unless the element is expressly recited using the phrase “means for” or, in the case of a method claim, the element is recited using the phrase “step for.”

We claim:

1. A method of mobile communication at a user equipment (UE), comprising:
starting a time-to-trigger (TTT) interval associated with a neighbor cell in preparation for potential handover of the UE to the neighbor cell according to network-assigned parameters;
monitoring a traffic-to-pilot ratio (TPR) associated with a downlink dedicated physical channel of a serving cell of the UE;
determining that the TPR exceeds a TPR threshold;
shortening the TTT interval upon a determination that the TPR exceeds the TPR threshold; and
transmitting, based on the shortened TTT interval, a Measurement Report Message (MRM) to a network to add the neighbor cell to an active set associated with the UE.

2. The method of claim 1, further comprising:
determining that a correlation exists between an estimated signal-to-interference ratio (SIRE) and a signal-to-interference ratio (Ec/Io) associated with a Common Pilot Channel (CPICH) over a time window; and
transmitting the MRM to the network upon a determination that the correlation exists.

3. The method of claim 2, wherein determining that the correlation exists between the SIRE and the Ec/Io comprises determining that a difference between the SIRE and the Ec/Io remains below a difference threshold over the time window.

4. The method of claim 1, wherein the network adds the neighbor cell to the active set based on a number of cells in the active set.

5. The method of claim 1, further comprising:
determining a per-link TPR associated with each cell of the active set;
comparing a greatest per-link TPR of a strongest cell having a greatest signal strength of the active set to the per-link TPR of each other cell of the active set to generate at least one per-link TPR difference;
determining that a greatest per-link difference of the at least one per-link TPR difference exceeds a TPR difference threshold;
determining that an event 1b could be reported to the network for the strongest cell according to the network-assigned parameters; and
postponing, based on a determination that the greatest-per link difference exceeds the TPR difference threshold, reporting the event 1b for the strongest cell until the TPR difference meets a link equality value.

6. The method of claim 1, further comprising shortening a compressed mode TTT associated with an event if reporting message or an event 2d reporting message upon a determination that the TPR meets a compressed mode TPR threshold.

7. The method of claim 1, further comprising altering a cell search procedure based upon the TPR.

8. The method of claim 7, wherein altering the cell search procedure comprises altering a periodicity or a threshold neighbor cell signal power level associated with the cell search procedure.

9. The method of claim 7, wherein the cell search procedure comprises one or more of an intra-frequency cell search, an inter-frequency cell search, and an inter-radio-access-technology cell search.

10. An apparatus for mobile communication, comprising:
means for starting a time-to-trigger (TTT) interval associated with a neighbor cell in preparation for potential handover of a UE to the neighbor cell according to network-assigned parameters;
means for monitoring a traffic-to-pilot ratio (TPR) associated with a downlink dedicated physical channel of a serving cell of the UE;
means for determining that the TPR exceeds a TPR threshold;
means for shortening the TTT interval upon a determination that the TPR exceeds the TPR threshold; and
means for transmitting, based on the shortened TTT interval, a Measurement Report Message (MRM) to a network to add the neighbor cell to an active set associated with the UE.

11. The apparatus of claim 10, further comprising:
means for determining that a correlation exists between an estimated signal-to-interference ratio (SIRE) and a signal-to-interference ratio (Ec/To) associated with a Common Pilot Channel (CPICH) over a time window; and
means for transmitting the MRM to the network upon a determination that the correlation exists.

12. The apparatus of claim 10, further comprising:
means for determining a per-link TPR associated with each cell of the active set;
means for comparing a greatest per-link TPR of a strongest cell having a greatest signal strength of the active set to the per-link TPR of each other cell of the active set to generate at least one per-link TPR difference;
means for determining that a greatest per-link difference of the at least one per-link TPR difference exceeds a TPR difference threshold;
means for determining that an event 1b could be reported to the network for the strongest cell according to the network-assigned parameters; and
means for postponing, based on a determination that the greatest-per link difference exceeds the TPR difference threshold, reporting the event 1b for the strongest cell until the TPR difference meets a link equality value.

13. The apparatus of claim 10, further comprising means for altering a cell search procedure based upon the TPR.

14. The apparatus of claim 13, wherein the means for altering the cell search procedure comprises means for altering a periodicity or a threshold neighbor cell signal power level associated with the cell search procedure.

15. The apparatus of claim 13, wherein the cell search procedure comprises one or more of an intra-frequency cell search, an inter-frequency cell search, and an inter-radio-access-technology cell search.

16. A non-transitory computer-readable storage medium, comprising instructions, that when executed by a processor, cause the processor to:
start a time-to-trigger (TTT) interval associated with a neighbor cell in preparation for potential handover of a UE to the neighbor cell according to network-assigned parameters;
monitor a traffic-to-pilot ratio (TPR) associated with a downlink dedicated physical channel of a serving cell of the UE;
determine that the TPR exceeds a TPR threshold;
shorten the TTT interval upon a determination that the TPR exceeds the TPR threshold; and
transmit, based on the shortened TTT interval, a Measurement Report Message (MRM) to a network to add the neighbor cell to an active set associated with the UE.

17. The computer-readable storage medium of claim 16, further comprising instructions, that when executed by the processor, cause the processor to:
determine that a correlation exists between an estimated signal-to-interference ratio (SIRE) and a signal-to-interference ratio (Echo) associated with a Common Pilot Channel (CPICH) over a time window; and
transmit the MRM to the network upon a determination that the correlation exists.

18. The computer-readable storage medium of claim 16, further comprising instructions, that when executed by the processor, cause the processor to:
determine a per-link TPR associated with each cell of the active set;
compare a greatest per-link TPR of a strongest cell having a greatest signal strength of the active set to the per-link TPR of each other cell of the active set to generate at least one per-link TPR difference;
determine that a greatest per-link difference of the at least one per-link TPR difference exceeds a TPR difference threshold;
determine that an event 1b could be reported to the network for the strongest cell according to the network-assigned parameters; and
postpone, based on a determination that the greatest-per link difference exceeds the TPR difference threshold, reporting the event 1b for the strongest cell until the TPR difference meets a link equality value.

19. The computer-readable storage medium of claim 16, further comprising instructions, that when executed by the processor, cause the processor to alter a cell search procedure based upon the TPR.

20. The computer-readable storage medium of claim 19, further comprising instructions, that when executed by the processor, cause the processor to altering a periodicity or a threshold neighbor cell signal power level associated with the cell search procedure.

21. The computer-readable storage medium of claim 19, wherein the cell search procedure comprises one or more of an intra-frequency cell search, an inter-frequency cell search, and an inter-radio-access-technology cell search.

22. A user equipment (UE), comprising:
a time-to-trigger (TTT) starting component configured to start a TTT interval associated with a neighbor cell in preparation for potential handover of the UE to the neighbor cell according to network-assigned parameters;
a traffic-to-pilot ratio (TPR) monitoring component configured to monitor a TPR associated with a downlink dedicated physical channel of a serving cell of the UE;
a comparison component configured to determine that the TPR exceeds a TPR threshold;
a TTT interval shortening component configured to shorten the TTT interval upon a determination that the TPR exceeds the TPR threshold; and
a Measurement Report Message (MRM) transmitting component configured to transmit, based on the shortened TTT interval, an MRM to a network to add the neighbor cell to an active set associated with the UE.

23. The UE of claim 22, further comprising:
a correlation determining component configured to determine that a correlation exists between an estimated signal-to-interference ratio (SIRE) and a signal-to-interference ratio (Ec/lo) associated with a Common Pilot Channel (CPICH) over a time window, and
wherein the MRM transmitting component is further configured to transmit the MRM to the network upon a determination that the correlation exists.

24. The UE of claim 23, wherein the correlation determining component is further configured to determine that a difference between the SIRE and the Ec/Io remains below a difference threshold over the time window.

25. The UE of claim 22, wherein the network adds the neighbor cell to the active set based on a number of cells in the active set.

26. The UE of claim 22, further comprising:
a per-link TPR determining component configured to determine a per-link TPR associated with each cell of the active set;
a TPR difference determining component configured to compare a greatest per-link TPR of a strongest cell having a greatest signal strength of the active set to the per-link TPR of each other cell of the active set to generate at least one per-link TPR difference;
a greatest difference determining component configured to determine that a greatest per-link difference of the at least one per-link TPR difference exceeds a TPR difference threshold;
an event reporting component configured to determine that an event 1b could be reported to the network for the strongest cell according to the network-assigned parameters; and
an event report postponing component configured to postpone, based on a determination that the greatest-per link difference exceeds the TPR difference threshold, reporting the event 1b for the strongest cell until the TPR difference meets a link equality value.

27. The UE of claim 22, further comprising a compressed mode TPR component configured to shorten a compressed mode TTT associated with an event if reporting message or an event 2d reporting message upon a determination that the TPR meets a compressed mode TPR threshold.

28. The UE of claim 22, further comprising a cell search altering component configured to alter a cell search procedure based upon the TPR.

29. The UE of claim 28, wherein the cell search altering component is further configured to alter a periodicity or a threshold neighbor cell signal power level associated with the cell search procedure.

30. The UE of claim 28, wherein the cell search procedure comprises one or more of an intra-frequency cell search, an inter-frequency cell search, and an inter-radio-access-technology cell search.
